(19) United States
(12) Patent Application Publication
(10) Pub. No.: US 2018/0016529 A1
(43) Pub. Date: Jan. 18, 2018

(54) KissAway Wipes

(71) Applicant: Kelly M. Hediger, Greensboro, GA (US)

(72) Inventor: Kelly M. Hediger, Greensboro, GA (US)

(21) Appl. No.: 15/211,342

(22) Filed: Jul. 15, 2016

(51) Int. Cl. C11D 17/04; B08B 1/00; C11D 7/26; C11D 11/00

(52) U.S. Cl. CPC C11D 17/049; C11D 11/0023; B08B 1/006; C11D 7/265

(57) ABSTRACT

A disposable sanitizing wipe impregnated with a non-toxic aqueous formulation for removing cosmetic residue (or lipstick) from rims of glass and ceramic drink ware

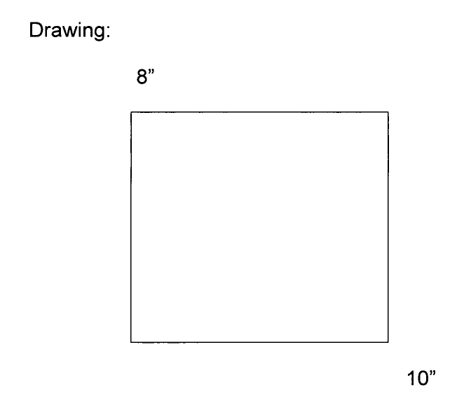

### SUMMARY OF THE INVENTION

All natural formulation for removing lipstick from rims of glass and ceramic drink ware. The composition compromising: 25% white distilled vinegar & 75% purified water.

### EXPLANATION OF OTHER USAGES OF APPLIED SOLUTION

Crystal drinkware

Ceramic drinkware

Ceramic and glass coffee cups

Everyday glassware

Barware

Banquet glassware

1. All natural formulation for removing lipstick stain from rims of glass and ceramic drink ware. The composition compromising: 25% white distilled vinegar & 75% purified water.

2. The method of claim 1 further comprising a hydraknit cloth of 8″×5″ sheet in peel/seal soft package impregnated with the all natural aqueous formulation for removing lipstick residue from rims of glass and ceramic drink ware.
